(19) United States
(12) Patent Application Publication
(10) Pub. No.: US 2025/0091733 A1
(43) Pub. Date: Mar. 20, 2025

(54) THRUSTER FOR MICRO-SATELLITE AND MANUFACTURING METHOD THEREOF

(71) Applicant: POSTECH RESEARCH AND BUSINESS DEVELOPMENT FOUNDATION, Pohang-si (KR)

(72) Inventors: Jeongrak LEE, Pohang-si (KR); Seonghyeon KIM, Pohang-si (KR); Anna LEE, Pohang-si (KR)

(21) Appl. No.: 18/827,975

(22) Filed: Sep. 9, 2024

(30) Foreign Application Priority Data
Sep. 15, 2023 (KR) 10-2023-0123312

(51) Int. Cl. B64G 1/26; B64G 1/40

(52) U.S. Cl. CPC B64G 1/26; B64G 1/409

(57) ABSTRACT

A thruster for a micro-satellite according to an embodiment of the present disclosure includes a first thrust module configured to generate a first thrust in a first direction, a second thrust module configured to generate a second thrust in a second direction intersecting the first direction, and a control substrate on which the first thrust module and the second thrust module are mounted, the control substrate being configured to control the first thrust module and the second thrust module, in which the first thrust module and the second thrust module includes a plurality of printed circuit boards stacked.

### CROSS-REFERENCE TO RELATED APPLICATION

This application claims the benefit of priority to Korean Patent Application No. 10-2023-0123312, filed on Sep. 15, 2023 in the Korean Intellectual Property Office. The aforementioned application is hereby incorporated by reference in its entirety.

### BACKGROUND OF THE INVENTION

### 1. Field of the Invention

The present disclosure relates to a thruster for a micro-satellite and a method of manufacturing the same.

### 2. Description of the Related Art

In general, spacecraft, which travel in space outside of the atmosphere, such as artificial satellites, space stations, and space telescopes orbiting the Earth, and space probes orbiting around other celestial bodies, include thrusters for maintaining position and controlling attitude on orbit, adjacent maneuvers during docking, and setting propulsion direction. The thrust refers to a propulsive force that a propellant receives in response to pushing surrounding fluids or combusting and ejecting fuel.

The spacecraft uses a rocket because there is no or little fluid. The rocket refers to a propulsion engine that allows the rocket to move forward by purely combusting fuel and ejecting high-pressure gas even in the absence of air. The rocket obtains a force required to allow the rocket to fly by discharging combustion gas, which is produced by the combustion of fuel and oxidant, to the outside of a nozzle of the engine. The rocket obtains a propulsive force by discharging gas to the outside to the extent of the momentum of the gas on the basis of the law of action-reaction or conservation of momentum.

Recently, micro-satellites called cube-sats or cube satellites have been developed. Unlike general artificial satellites, the micro-satellite has a small size, simple design, and durability, such that components embedded in the micro-satellite may be maintained without being destroyed. In addition, because the micro-satellite has a standardized size, a plurality of micro-satellites may be launched by using the same projectile. Therefore, a large number of micro-satellites may be produced with low costs. Even though the micro-satellite cannot perform as various and large tasks as a general artificial satellite, a plurality of or several to tens of micro-satellites may be launched and cover a large range. Because the plurality of micro-satellites flies in formation, thrusters are essential for posture control, spacing, and the like.

However, because a thruster mounted in the spacecraft in the related art is large and heavy, it is difficult to apply the thruster to the micro-satellite. In addition, a chemical thruster also requires additional devices such as an igniter, a valve, and a propellant tank, which increases weight and manufacturing costs of the thruster. In addition, various types of electric thrusters are also being developed. However, because the electric thruster requires excessively large electric power consumption and produces a low propulsive force, the electric thruster is not suitable for use in the micro-satellite.

### SUMMARY OF THE INVENTION

The present disclosure attempts to provide a thruster for a micro-satellite having various structures and performance and configured to be easy to manufacture.

A thruster for a micro-satellite according to an embodiment of the present disclosure includes: a first thrust module configured to generate a first thrust in a first direction; a second thrust module configured to generate a second thrust in a second direction intersecting the first direction; and a control substrate on which the first thrust module and the second thrust module are mounted, the control substrate being configured to control the first thrust module and the second thrust module, in which the first thrust module and the second thrust module includes a plurality of printed circuit boards stacked.

The first thrust module may include: a first substrate assembly including the plurality of printed circuit boards; a first injector installed in the first substrate assembly and configured to inject a propellant; a first catalyst chamber installed in the first substrate assembly and connected to the first injector, a catalyst being positioned in the first catalyst chamber; and a first nozzle installed in the first substrate assembly and configured to generate the first thrust by discharging a first thrust gas, which is generated from the first catalyst chamber, to the outside of the first substrate assembly.

The second thrust module may include: a second substrate assembly including the plurality of printed circuit boards; a second injector installed in the second substrate assembly and configured to inject a propellant; a second catalyst chamber installed in the second substrate assembly and connected to the second injector; and a second nozzle installed in the second substrate assembly and configured to generate the second thrust by discharging a thrust gas, which is generated from the second catalyst chamber, to the outside of the second substrate assembly.

The first injector and the second injector may be formed by stacking a plurality of injector holes formed in the plurality of printed circuit boards.

The first catalyst chamber and the second catalyst chamber may be formed by stacking a plurality of chamber holes formed in the plurality of printed circuit boards.

The first nozzle or the second nozzle may be connected to any one of the plurality of chamber holes.

The second thrust module and the first thrust module may further include couplers coupled to the control substrate.

In addition, a method of manufacturing a thruster for a micro-satellite according to another embodiment of the present disclosure includes: manufacturing a first thrust module, which is configured to generate a first thrust in a first direction, by stacking a plurality of printed circuit boards; manufacturing a second thrust module, which is configured to generate a second thrust in a second direction intersecting the first direction, by stacking the plurality of printed circuit boards; and coupling the first thrust module and the second thrust module onto a control substrate.

The manufacturing of the first thrust module may include: forming a bonding agent pattern on a conductive layer of the plurality of printed circuit boards; aligning and stacking some of the plurality of printed circuit boards; inserting a catalyst into a first catalyst chamber formed by stacking a plurality of chamber holes formed in some of the printed circuit boards; and coupling an uppermost printed circuit board onto some of the printed circuit boards, in which a first nozzle, which is connected to the chamber hole and parallel to a surface of the printed circuit board, is installed in some of the printed circuit boards.

In the inserting of the catalyst into the first catalyst chamber, a first catalyst withdrawal prevention member may be inserted between the first nozzle and the first catalyst chamber installed in the printed circuit board, and the first catalyst withdrawal prevention member may be installed to intersect an extension direction of the first nozzle.

The manufacturing of the second thrust module may include: forming a bonding agent pattern on a conductive layer of the plurality of printed circuit boards; aligning and stacking some of the plurality of printed circuit boards; inserting a catalyst into a second catalyst chamber formed by stacking a plurality of chamber holes formed in some of the printed circuit boards; and coupling an uppermost printed circuit board onto some of the printed circuit boards, in which a second nozzle, which is connected to the chamber hole and perpendicular to a surface of the printed circuit board, is installed in some of the uppermost printed circuit board.

In the inserting of the catalyst into the second catalyst chamber, a second catalyst withdrawal prevention member may be inserted between the second nozzle and the second catalyst chamber installed in the uppermost printed circuit board, and the second catalyst withdrawal prevention member may be installed to intersect an extension direction of the second nozzle.

The forming of the bonding agent pattern may include: aligning a metal mask having a plurality of opening portions on a conductive layer of the printed circuit board; and forming a bonding agent pattern by applying bonding agent paste on the conductive layer through the plurality of opening portions.

According to the thruster for a micro-satellite according to the embodiment of the present disclosure, the injectors, the catalyst chambers, and the nozzles may be manufactured by stacking the printed circuit boards (PCBs) by using the surface mount technology (SMT), such that the thrusters with various structures may be easily manufactured.

In addition, the plurality of first thrust modules and the plurality of second thrust modules are mounted on the control substrate including the printed circuit boards while having differences in numbers, arrangements, assembling orders, and the like, such that the thrusters with various structures and performance may be easily manufactured.

### BRIEF DESCRIPTION OF THE DRAWINGS

FIG. 1 is a perspective view of a thruster for a micro-satellite according to an embodiment of the present disclosure.

FIG. 2 is a top plan view of the thruster for a micro-satellite according to the embodiment of the present disclosure.

FIG. 3 is a cross-sectional view of a first thrust module in FIG. 1.

FIG. 4 is an exploded perspective view of FIG. 3.

FIG. 5 is a cross-sectional view of a second thrust module in FIG. 1.

FIG. 6 is an exploded perspective view of FIG. 5.

FIG. 7 is a schematic flowchart of a method of manufacturing the thruster for a micro-satellite according to the embodiment of the present disclosure.

FIGS. 8 to 13 are views sequentially illustrating a first step of the method of manufacturing the thruster for a micro-satellite according to the embodiment of the present disclosure.

### DETAILED DESCRIPTION OF THE EMBODIMENTS

Hereinafter, several exemplary embodiments of the present disclosure will be described in detail with reference to the accompanying drawings so that those with ordinary skill in the art to which the present disclosure pertains may easily carry out the exemplary embodiments. The present disclosure may be implemented in various different ways and is not limited to the embodiments described herein.

A part irrelevant to the description will be omitted to clearly describe the present disclosure, and the same or similar constituent elements will be designated by the same reference numerals throughout the specification.

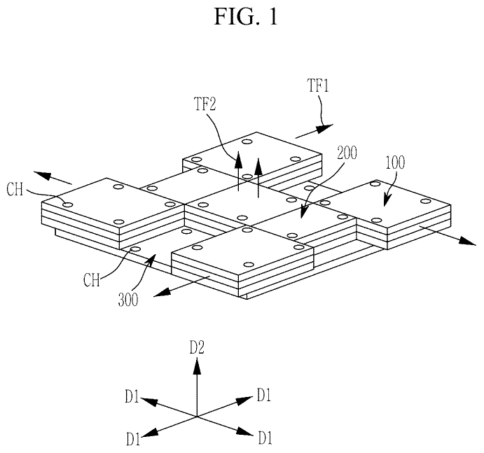

Then, a thruster for a micro-satellite according to an embodiment of the present disclosure will be described in detail with reference to FIGS. 1 to 6.

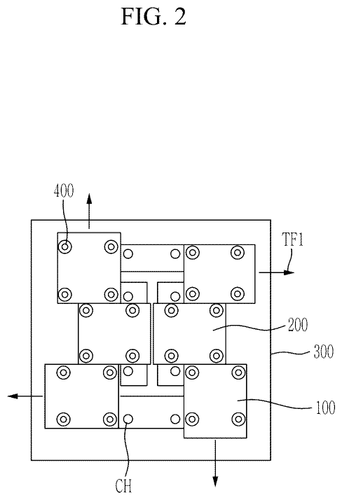

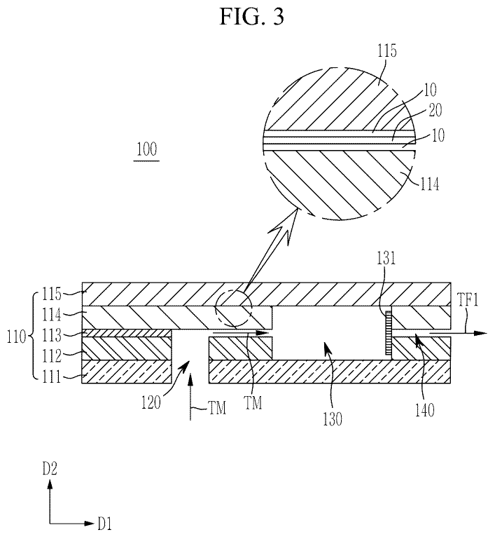

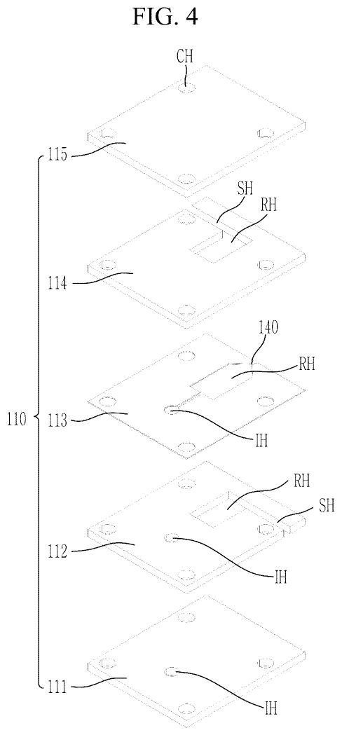

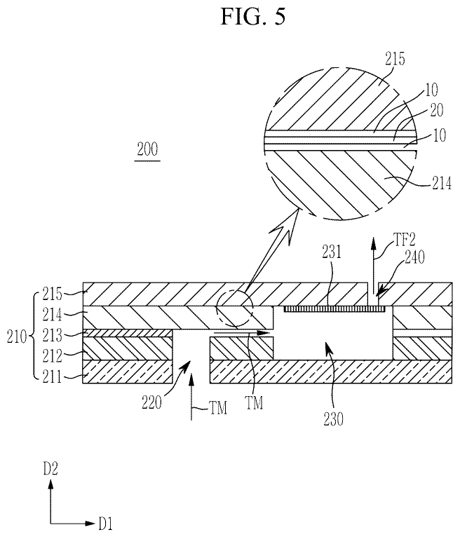

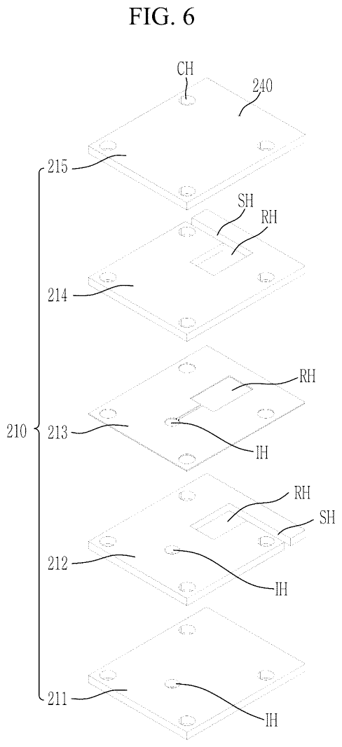

FIG. 1 is a perspective view of a thruster for a micro-satellite according to an embodiment of the present disclosure, FIG. 2 is a top plan view of the thruster for a micro-satellite according to the embodiment of the present disclosure, FIG. 3 is a cross-sectional view of a first thrust module in FIG. 1, FIG. 4 is an exploded perspective view of FIG. 3, FIG. 5 is a cross-sectional view of a second thrust module in FIG. 1, and FIG. 6 is an exploded perspective view of FIG. 5.

As illustrated in FIGS. 1 to 6, the thruster for a micro-satellite according to the embodiment of the present disclosure includes a first thrust module 100, a second thrust module 200, a control substrate 300, and a coupler 400.

The first thrust module 100 may generate a first thrust TF1 in a first direction D1. The first direction D1 may be a direction parallel to a surface of a first substrate assembly 110. As illustrated in FIG. 1, the first direction D1 may mean four directions, i.e., upward, downward, leftward, and rightward directions. The first thrust module 100 may include the first substrate assembly 110, a first injector 120, a first catalyst chamber 130, and a first nozzle 140.

The first substrate assembly 110 may include a plurality of printed circuit boards (PCBs) 111, 112, 113, 114, and 115 stacked. The printed circuit board (PCB) includes FR-4 (glass-reinforced epoxy laminate material), and FR-4 has very low thermal conductivity (0.2 W/mK), such that a deterioration in propulsion efficiency caused by heat dissipation may be overcome. In addition, because FR-4 has high corrasion resistance, a deterioration in performance caused by structural deformation may be minimized, and stable long-term performance may be provided.

In the present embodiment, the configuration has been described in which the first substrate assembly 110 has a structure in which five printed circuit boards (PCBs) are stacked. However, the present disclosure is not necessarily limited thereto. The first substrate assembly 110 may be formed by stacking various numbers of printed circuit boards.

The first substrate assembly 110 may include a first_first printed circuit board 111, a first_second printed circuit board 112, a first_third printed circuit board 113, a first_fourth printed circuit board 114, and a first-fifth printed circuit board 115 sequentially stacked. The first_first printed circuit board 111, the first_second printed circuit board 112, the first_third printed circuit board 113, the first_fourth printed circuit board 114, and the first-fifth printed circuit board 115 may have the same size. The first_third printed circuit board 113 positioned at a center has the first nozzle 140 that exhibits higher performance as a thickness decreases. Therefore, a thickness of the first_third printed circuit board 113 may be smaller than a thickness of each of the first_first printed circuit board 111, the first_second printed circuit board 112, the first_fourth printed circuit board 114, and the first-fifth printed circuit board 115.

Conductive layers 10 and bonding members 20 may be sequentially stacked on two opposite surfaces of each of the first_first to first_fifth printed circuit boards 111, 112, 113, 114, and 115. The conductive layer 10 may include copper, and the bonding member 20 may include epoxy resin. A plating layer (not illustrated), such as electroless nickel immersion gold (ENIG), may be formed between the conductive layer 10 and the bonding member 20 to prevent corrosion of the conductive layer. A surface mount technology (SMT) including stencil printing and soldering processes may be performed onto the conductive layer 10 to form the bonding member 20 with a uniform thickness. FIG. 3 is an enlarged view of a portion where the first_fourth printed circuit board 114 and the first-fifth printed circuit board 115 are in contact with each other by the bonding member 20. A plurality of coupling holes CH may be formed in the first_first to first_fifth printed circuit boards 111, 112, 113, 114, and 115 to couple the first_first to first_fifth printed circuit boards 111, 112, 113, 114, and 115. For example, in the present embodiment, four coupling holes CH may be formed around four edges of each of the printed circuit boards 111, 112, 113, 114, and 115. The couplers 400 may be fastened to the coupling holes CH to couple the first_first to first_fifth printed circuit boards 111, 112, 113, 114, and 115, such that the first substrate assembly 110 may be manufactured. Further, the couplers 400 may be fastened to the coupling holes CH formed in the control substrate 300 to mount the first substrate assembly 110 on the control substrate 300.

Injector holes IH for defining the first injector 120 may be formed in the first_first printed circuit board 111, the first_second printed circuit board 112, and the first_third printed circuit board 113. However, the printed circuit board having the injector hole IH is not necessarily limited thereto, and the printed circuit board may be variously modified.

Chamber holes RH for defining the first catalyst chamber 130 may be formed in the first_second printed circuit board 112, the first_third printed circuit board 113, and the first_fourth printed circuit board 114.

Sensor connection holes SH connected to the chamber holes RH may be formed in the first_second printed circuit board 112 and the first_fourth printed circuit board 114. The sensor connection hole SH may be connected to a temperature sensor, a pressure sensor, and the like and measure a temperature, a pressure, and the like in the catalyst chamber. However, the printed circuit board having the sensor connection hole SH is not necessarily limited thereto, and the printed circuit board may be variously modified.

The first injector 120 may be installed in the first substrate assembly 110 and configured to inject a propellant TM. The first injector 120 may be formed by stacking the plurality of injector holes IH formed in the first_first printed circuit board 111, the first_second printed circuit board 112, and the first_third printed circuit board 113.

The first catalyst chamber 130 may be installed in the first substrate assembly 110 and connected to the first injector 120, such that a catalyst such as a platinum catalyst may be positioned in the first catalyst chamber 130. The first catalyst chamber 130 may be formed by stacking the plurality of chamber holes RH formed in the first_second printed circuit board 112, the first_third printed circuit board 113, and the first_fourth printed circuit board 114. A first catalyst withdrawal prevention member 131 may be installed between the first nozzle 140 and the first catalyst chamber 130. The first catalyst withdrawal prevention member 131 may be installed to intersect an extension direction of the first nozzle 140 and prevent the catalyst from being withdrawn through the first nozzle 140. The first catalyst withdrawal prevention member 131 may have a metal mesh shape.

The first nozzle 140 may be installed on the first_third printed circuit board 113 of the first substrate assembly 110 and generate the first thrust TF1 while discharging a first thrust gas, which is generated from the first catalyst chamber 130, to the outside of the first substrate assembly 110. The first nozzle 140 may be connected to any one of the plurality of chamber holes RH. In the present embodiment, the first nozzle 140 may be connected to the chamber hole RH formed in the first_third printed circuit board 113.

The second thrust module 200 may generate a second thrust TF2 in a second direction D2 intersecting the first direction D1. The second direction D2 may be a direction perpendicular to a surface of a second substrate assembly 210.

The second thrust module 200 may include the second substrate assembly 210, a second injector 220, a second catalyst chamber 230, and a second nozzle 240.

The second substrate assembly 210 may include a plurality of printed circuit boards 211, 212, 213, 214, and 215 stacked. The printed circuit board (PCB) includes FR-4 (glass-reinforced epoxy laminate material), and FR-4 has very low thermal conductivity (0.2 W/mK), such that the printed circuit board may have robust physical properties.

In the present embodiment, the configuration has been described in which the second substrate assembly 210 has a structure in which five printed circuit boards (PCBs) are stacked. However, the present disclosure is not necessarily limited thereto. The second substrate assembly 210 may be formed by stacking various numbers of printed circuit boards.

The second substrate assembly 210 may include a second_first printed circuit board 211, a second_second printed circuit board 212, a second_third printed circuit board 213, a second_fourth printed circuit board 214, and a second-fifth printed circuit board 215 sequentially stacked. The second_first printed circuit board 211, the second_second printed circuit board 212, the second_third printed circuit board 213, the second_fourth printed circuit board 214, and the second-fifth printed circuit board 215 may have the same size. The second_third printed circuit board 213 positioned at a center has the first nozzle 240 that exhibits higher performance as a thickness decreases. Therefore, a thickness of the second_third printed circuit board 213 may be smaller than a thickness of each of the second_first printed circuit board 211, the second_second printed circuit board 212, the second_fourth printed circuit board 214, and the first-fifth printed circuit board 215. Conductive layers 10 and bonding members 20 may be sequentially stacked on two opposite surfaces of each of the second_first to second_fifth printed circuit boards 211, 212, 213, 214, and 215. The stencil printing and soldering processes may be performed onto the conductive layer 10 to form the bonding member 20 with a uniform thickness. FIG. 5 is an enlarged view of a portion where the second_fourth printed circuit board 214 and the second-fifth printed circuit board 215 are in contact with each other by the bonding member 20. A plurality of coupling holes CH may be formed in the second_first to second_fifth printed circuit boards 211, 212, 213, 214, and 215 to couple the second_first to second_fifth printed circuit boards 211, 212, 213, 214, and 215. For example, in the present embodiment, four coupling holes CH may be formed around four edges of each of the printed circuit boards 211, 212, 213, 214, and 215. The couplers 400 may be fastened to the coupling holes CH to couple the second_first to second_fifth printed circuit boards 211, 212, 213, 214, and 215, such that the second substrate assembly 210 may be manufactured. Further, the couplers 400 may be fastened to the coupling holes CH formed in the control substrate 300 to mount the second substrate assembly 210 on the control substrate 300.

Injector holes IH for defining the second injector 120 may be formed in the second_first printed circuit board 211, the second_second printed circuit board 212, and the second_third printed circuit board 213.

Chamber holes RH for defining the second catalyst chamber 230 may be formed in the second_second printed circuit board 212, the second_third printed circuit board 213, and the second_fourth printed circuit board 214.

Sensor connection holes SH connected to the chamber holes RH may be formed in the second_second printed circuit board 212 and the second_fourth printed circuit board 214. The sensor connection hole SH may be connected to a temperature sensor, a pressure sensor, and the like and measure a temperature, a pressure, and the like in the catalyst chamber. However, the printed circuit board having the sensor connection hole SH is not necessarily limited thereto, and the printed circuit board may be variously modified.

The second injector 220 may be installed in the second substrate assembly 210 and configured to inject the propellant TM. The second injector 220 may be formed by stacking the plurality of injector holes IH formed in the second_first printed circuit board 211, the second_second printed circuit board 212, and the second_third printed circuit board 213.

The second catalyst chamber 230 may be installed in the second substrate assembly 210 and connected to the second injector 220. The second catalyst chamber 230 may be formed by stacking the plurality of chamber holes RH formed in the second_second printed circuit board 212, the second_third printed circuit board 213, and the second_fourth printed circuit board 214. A second catalyst withdrawal prevention member 231 may be installed between the second nozzle 240 and the second catalyst chamber 230. The second catalyst withdrawal prevention member 231 may be installed to intersect an extension direction of the second nozzle 240 and prevent the catalyst from being withdrawn through the second nozzle 240. The second catalyst withdrawal prevention member 231 may have a metal mesh shape.

The second nozzle 240 may be installed in a second_fifth printed circuit board 215 of the second substrate assembly 210 and generate the second thrust TF2 by discharging a second thrust gas, which is generated from the second catalyst chamber 230, to the outside of the second substrate assembly 210. The second nozzle 240 may be connected to any one of the plurality of chamber holes RH. In the present embodiment, the second nozzle 240 may be connected to the chamber hole RH formed in the second_fourth printed circuit board 214.

The control substrate 300 may be mounted on the first thrust module 100 and the second thrust module 200 and control the first thrust module 100 and the second thrust module 200. The control substrate 300 may be configured as a printed circuit board (PCB), and the printed circuit board (PCB) may include FR-4 (glass-reinforced epoxy laminate material). The plurality of coupling holes CH may be formed in the control substrate 300, and the modularized first thrust module 100 and the modularized second thrust module 200 are coupled to the plurality of coupling holes CH by using the couplers 400, such that various types of thrust modules 100 and 200 may be easily mounted at various positions with various structures. In the present embodiment, two types of thrust modules, i.e., the first thrust module 100 and the second thrust module 200 are disclosed. However, the present disclosure is not necessarily limited thereto. Various types of thrust modules may be applied.

In addition, because the control substrate 300 includes the printed circuit board, the components for operating and controlling the thrust module, e.g., components such as a micro-processor (MCU), a battery (Battery), and a communication module may be attached to the control substrate 300. In addition, a valve, such as a solenoid valve and a check valve, for controlling a process of injecting the propellant into the injector from a propellant tank, and a sensor, such as a temperature sensor and a pressure sensor, for monitoring states may be coupled to the control substrate by using the soldering process.

The couplers 400 may include fastening members such as bolts and nuts. Various types of thrust modules, such as the modularized first thrust module 100 and the modularized second thrust module 200, may be easily mounted at various positions on the control substrate 300 with various structures by using the coupler 400

In the related art, microelectromechanical systems (MEMS) have been used to manufacture thrusters for micro-satellites that include microfluidic components such as injectors, catalytic chambers, and nozzles. When the microelectromechanical systems (MEMS) are made of highly brittle materials, such as silicon and glass, and are used to manufacture thrusters for micro-satellites, the thrusters are more likely to be damaged by internal and external impacts. In addition, the thermal conductivity of highly brittle materials such as silicon and glass is relatively high, resulting in a high volume-to-surface area ratio, which results in high heat loss. In addition, it is difficult to increase a scale of the thruster for a micro-satellite and mass-produce thrusters for micro-satellites by using the microelectromechanical systems (MEMS).

In contrast, according to the thruster for a micro-satellite according to the embodiment of the present disclosure, electronic control components and microfluidic components, such as the injectors, the catalyst chambers, and the nozzles, may be implemented by using the printed circuit boards. Therefore, the thruster has robust physical properties and very low thermal conductivity, which may minimize a thermal loss and mass-produce thrusters for micro-satellites with precise dimensions with reasonable and low costs.

Hereinafter, the operation of the thruster for a micro-satellite according to the embodiment of the present disclosure will be described in detail.

As illustrated in FIGS. 3 and 4, when the propellant TM is injected into the first injector 120 of the first thrust module 100 by an injection means such as a syringe pump, the propellant TM is transferred from the first injector 120 to the first catalyst chamber 130. Further, the first thrust gas, which is generated when the propellant TM is decomposed by the catalyst in the first catalyst chamber 130, is accelerated by the first nozzle 140, such that the first thrust TF1 is generated in the horizontal direction, i.e., the first direction D1.

In addition, as illustrated in FIGS. 5 and 6, when the propellant TM is injected into the second injector 220 of the second thrust module 200 by an injection means such as a syringe pump, the propellant TM is transferred from the second injector 220 to the second catalyst chamber 230. Further, the second thrust gas, which is generated when the propellant TM is decomposed by the catalyst in the second catalyst chamber 230, is accelerated by the second nozzle 240, such that the second thrust TF2 is generated in the vertical direction, i.e., the second direction D2.

A method of manufacturing the thruster for a micro-satellite according to the embodiment of the present disclosure will be described in detail with reference to the drawings.

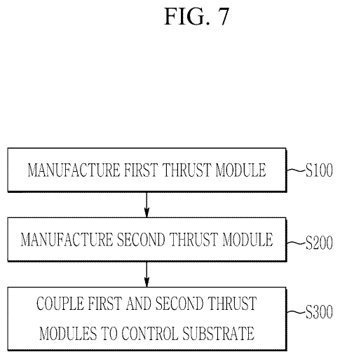

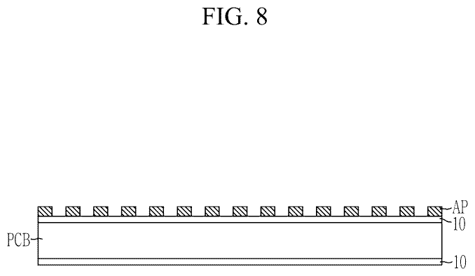

FIG. 7 is a schematic flowchart of a method of manufacturing the thruster for a micro-satellite according to the embodiment of the present disclosure, and FIGS. 8 to 12 are views sequentially illustrating a first step of the method of manufacturing the thruster for a micro-satellite according to the embodiment of the present disclosure.

First, as illustrated in FIGS. 7 to 11, the first thrust module 100 is manufactured (S100). The first thrust module 100 may include the first substrate assembly 110, the first injector 120, the first catalyst chamber 130, and the first nozzle 140.

A method of manufacturing the first thrust module 100 will be described below in detail with reference to the drawings.

First, as illustrated in FIG. 8, a bonding agent pattern AP is formed on the conductive layer 10 of the plurality of printed circuit boards (PCBs). In order to form the bonding agent pattern AP, a metal mask having a plurality of opening portions having mesh shapes is aligned on the conductive layer 10 of the printed circuit board (PCB). Further, bonding agent paste is applied onto the conductive layer 10 through the plurality of opening portions by using a putty knife. The bonding agent paste may include epoxy-solder paste or the like. Further, as illustrated in FIG. 8, the bonding agent pattern AP is formed on the conductive layer 10 by removing the metal mask.

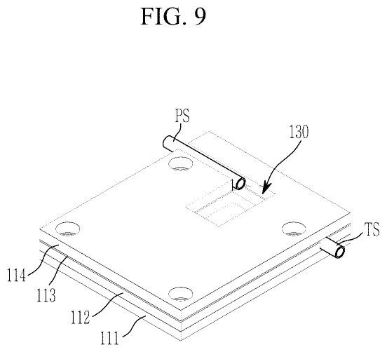

Next, as illustrated in FIG. 9, some of the plurality of printed circuit boards are aligned and stacked. In the present embodiment, the first_first printed circuit board 111, the first_second printed circuit board 112, the first_third printed circuit board 113, and the first_fourth printed circuit board 114 are aligned and stacked. In this case, the first injector 120 may be formed in the plurality of injector holes IH, the first catalyst chamber 130 may be formed in the plurality of chamber holes RH, and the first nozzle 140 may be formed in the first_third printed circuit board 113. The first nozzle 140 may be parallel to the surface of the printed circuit board. In addition, a temperature sensor TS, such as a thermocouple, or a pressure sensor PS may be inserted into the sensor connection holes SH formed in the first_second printed circuit board 112 and the first_fourth printed circuit board 114, and the sensor connection hole SH is sealed by a sealing member such as epoxy resin.

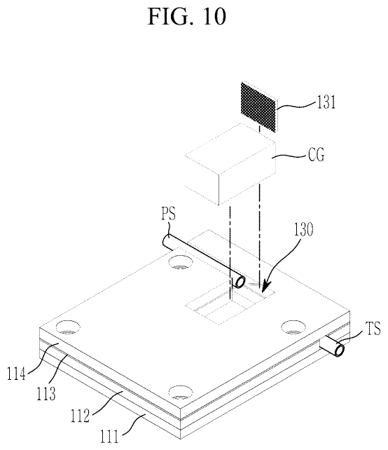

Next, as illustrated in FIG. 10, a catalyst CG is inserted into the first catalyst chamber 130, and the first catalyst withdrawal prevention member 131 is inserted between the first nozzle 140 and the first catalyst chamber 130. The first catalyst withdrawal prevention member 131 may be installed to intersect an extension direction of the first nozzle 140 and prevent the catalyst CG from being withdrawn through the first nozzle 140.

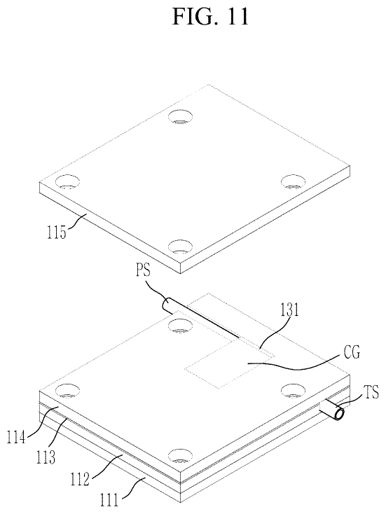

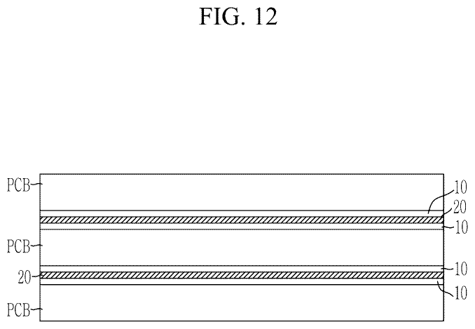

Next, as illustrated in FIG. 11, an uppermost printed circuit board is coupled to some of the printed circuit boards. In the present embodiment, the first-fifth printed circuit board 115 is coupled to the first_fourth printed circuit board 114. Further, in the state in which all the printed circuit boards (PCBs) are stacked, all the printed circuit boards (PCBs) are joined by using a soldering process. That is, as illustrated in FIG. 12, the bonding agent pattern AP is melted by using a heating device such as an oven so that the bonding member 20 is spread on the entire surface of the conductive layer 10. Thereafter, the bonding agent pattern AP may be cured to join all the printed circuit boards (PCBs). As described above, the bonding agent pattern AP may be formed by applying the bonding agent paste, and then the bonding member 20 may be formed by melting the bonding agent pattern AP, such that the bonding member 20 with a uniform thickness may be formed on the conductive layer 10.

Next, as illustrated in FIGS. 7 to 13, the second thrust module 200 is manufactured (S200). The second thrust module 200 may include the second substrate assembly 210, the second injector 220, the second catalyst chamber 230, and the second nozzle 240.

The method of manufacturing the second thrust module 200 is substantially identical to the method of manufacturing the first thrust module 100, except for the structures of the second nozzle 240 and the second catalyst withdrawal prevention member 231. Therefore, a repeated description thereof will be omitted.

As illustrated in FIG. 9, the bonding agent pattern AP is formed on the conductive layer 10 of the plurality of printed circuit boards (PCBs). Further, some of the plurality of printed circuit boards are aligned and stacked. In the present embodiment, the second_first printed circuit board 211, the second_second printed circuit board 212, the second_third printed circuit board 213, and the second_fourth printed circuit board 214 are aligned and stacked.

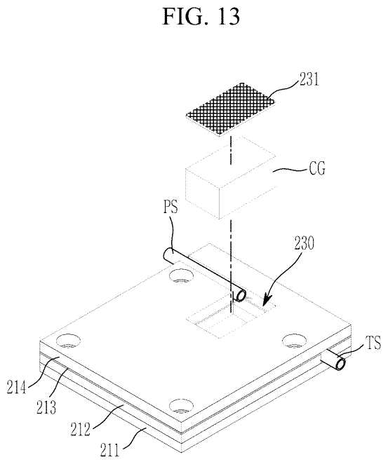

Next, as illustrated in FIG. 13, the catalyst CG is inserted into the second catalyst chamber 230, and the second catalyst withdrawal prevention member 231 is installed on the second catalyst CG. The second catalyst withdrawal prevention member 231 may be installed to intersect the extension direction of the second nozzle 240 and prevent the catalyst CG from being withdrawn through the second nozzle 240.

Next, as illustrated in FIG. 7, an uppermost printed circuit board is coupled to some of the printed circuit boards. In the present embodiment, the second-fifth printed circuit board 215 is coupled to the second_fourth printed circuit board 214. Further, in the state in which all the printed circuit boards (PCBs) are stacked, all the printed circuit boards (PCBs) are joined by using a soldering process.

Next, as illustrated in FIGS. 2 and 7, the first thrust module 100 and the second thrust module 200 are mounted on the control substrate 300, and the first thrust module 100 and the second thrust module 200 are coupled to the control substrate 300 by using the coupler 400 (S300).

The plurality of coupling holes CH may be formed in the control substrate 300, and the modularized first thrust module 100 and the modularized second thrust module 200 are coupled to the plurality of coupling holes CH by using the couplers 400, such that various types of thrust modules 100 and 200 may be easily mounted at various positions with various structures.

As described above, according to the thruster for a micro-satellite according to the embodiment of the present disclosure, the injectors, the catalyst chambers, and the nozzles may be manufactured by stacking the printed circuit boards (PCBs) by using the surface mount technology (SMT), such that the thrusters with various structures may be easily manufactured.

In addition, the plurality of first thrust modules and the plurality of second thrust modules are mounted on the control substrate including the printed circuit boards while having differences in numbers, arrangements, assembling orders, and the like, such that the thrusters with various structures and performance may be easily manufactured.

While the present disclosure has been described with reference to the aforementioned exemplary embodiments, the person skilled in the art will easily understand that the present disclosure is not limited to the disclosed exemplary embodiments, but can be variously corrected and modified without departing from the spirit and scope of the appended claims.

<Description of symbols>

| | |
|---|---|
| 100: First thrust module | 110: First substrate assembly |
| 120: First injector | 130: First catalyst chamber |
| 140: First nozzle | 200: Second thrust module |
| 210: Second substrate assembly | 220: Second injector |
| 230: Second catalyst chamber | 240: Second nozzle |
| 300: Control substrate | 400: Coupler |

What is claimed is:

1. A thruster for a micro-satellite, the thruster comprising:
a first thrust module configured to generate a first thrust in a first direction;
a second thrust module configured to generate a second thrust in a second direction intersecting the first direction; and
a control substrate on which the first thrust module and the second thrust module are mounted, the control substrate being configured to control the first thrust module and the second thrust module,
wherein the first thrust module and the second thrust module comprises a plurality of printed circuit boards stacked.

2. The thruster of claim 1, wherein:
the first thrust module comprises:
a first substrate assembly comprising the plurality of printed circuit boards;
a first injector installed in the first substrate assembly and configured to inject a propellant;
a first catalyst chamber installed in the first substrate assembly and connected to the first injector, a catalyst being positioned in the first catalyst chamber; and
a first nozzle installed in the first substrate assembly and configured to generate the first thrust by discharging a first thrust gas, which is generated from the first catalyst chamber, to the outside of the first substrate assembly.

3. The thruster of claim 2, wherein:
the second thrust module comprises:
a second substrate assembly including the plurality of printed circuit boards;
a second injector installed in the second substrate assembly and configured to inject a propellant;
a second catalyst chamber installed in the second substrate assembly and connected to the second injector; and
a second nozzle installed in the second substrate assembly and configured to generate the second thrust by discharging a thrust gas, which is generated from the second catalyst chamber, to the outside of the second substrate assembly.

4. The thruster of claim 3, wherein:
the first injector and the second injector are formed by stacking a plurality of injector holes formed in the plurality of printed circuit boards.

5. The thruster of claim 4, wherein:
the first catalyst chamber and the second catalyst chamber are formed by stacking a plurality of chamber holes formed in the plurality of printed circuit boards.

6. The thruster of claim 5, wherein:
the first nozzle or the second nozzle is connected to any one of the plurality of chamber holes.

7. The thruster of claim 1, further comprising:
the second thrust module and the first thrust module further comprise couplers coupled to the control substrate.

8. A method of manufacturing a thruster for a micro-satellite, the method comprising:
manufacturing a first thrust module, which is configured to generate a first thrust in a first direction, by stacking a plurality of printed circuit boards;
manufacturing a second thrust module, which is configured to generate a second thrust in a second direction intersecting the first direction, by stacking the plurality of printed circuit boards; and
coupling the first thrust module and the second thrust module onto a control substrate.

9. The method of claim 8, wherein:
the manufacturing of the first thrust module comprises:
forming a bonding agent pattern on a conductive layer of the plurality of printed circuit boards;
aligning and stacking some of the plurality of printed circuit boards;
inserting a catalyst into a first catalyst chamber formed by stacking a plurality of chamber holes formed in some of the printed circuit boards; and
coupling an uppermost printed circuit board onto some of the printed circuit boards,
wherein a first nozzle, which is connected to the chamber hole and parallel to a surface of the printed circuit board, is installed in some of the printed circuit boards.

10. The method of claim 9, wherein:
in the inserting of the catalyst into the first catalyst chamber,
a first catalyst withdrawal prevention member is inserted between the first nozzle and the first catalyst chamber installed in the printed circuit board, and
the first catalyst withdrawal prevention member is installed to intersect an extension direction of the first nozzle.

11. The method of claim 9, wherein:
the manufacturing of the second thrust module comprises:
forming a bonding agent pattern on a conductive layer of the plurality of printed circuit boards;
aligning and stacking some of the plurality of printed circuit boards;
inserting a catalyst into a second catalyst chamber formed by stacking a plurality of chamber holes formed in some of the printed circuit boards; and
coupling an uppermost printed circuit board onto some of the printed circuit boards,
wherein a second nozzle, which is connected to the chamber hole and perpendicular to a surface of the printed circuit board, is installed in some of the uppermost printed circuit board.

12. The method of claim 11, wherein:
in the inserting of the catalyst into the second catalyst chamber,
a second catalyst withdrawal prevention member is inserted between the second nozzle and the second catalyst chamber installed in the uppermost printed circuit board, and
the second catalyst withdrawal prevention member is installed to intersect an extension direction of the second nozzle.

13. The method of claim 9, wherein:
the forming of the bonding agent pattern comprises:
aligning a metal mask having a plurality of opening portions on a conductive layer of the printed circuit board; and
forming a bonding agent pattern by applying bonding agent paste on the conductive layer through the plurality of opening portions.
